(19) United States
(12) Patent Application Publication
(10) Pub. No.: US 2015/0106301 A1
(43) Pub. Date: Apr. 16, 2015

(54) PREDICTIVE MODELING IN IN-MEMORY MODELING ENVIRONMENT METHOD AND APPARATUS

(71) Applicant: MASTERCARD INTERNATIONAL INCORPORATED, Purchase, NY (US)

(72) Inventors: Tong ZHANG, Greenwich, CT (US); Po Hu, Norwalk, CT (US)

(73) Assignee: MASTERCARD INTERNATIONAL INCORPORATED, Purchase, NY (US)

(21) Appl. No.: 14/051,231

(22) Filed: Oct. 10, 2013

(51) Int. Cl. G06F 17/30; G06Q 10/06

(52) U.S. Cl. CPC G06F 17/30595; G06Q 10/067
USPC 705/348; 707/803

(57) ABSTRACT

A system, method, and computer readable storage medium configured to model large amounts of data in an in-memory modeling environment.

### BACKGROUND

1. Field of the Disclosure

Aspects of the disclosure relate in general to the processing, analysis, and modeling of large amounts of data. Aspects include an apparatus, system, method and computer readable storage medium to model large amounts of data in an in-memory modeling environment.

2. Description of the Related Art

“Big data” is a term for data sets so large and complex that it becomes difficult to process using on-hand database management tools or traditional data processing applications. The challenges include capture, storage, search, sharing, transfer, analysis, and visualization. The trend to larger data sets is due to the additional information derivable from analysis of a single large set of related data, as compared to separate smaller sets with the same total amount of data, allowing correlations to be found to analyze financial transactions and data, spot business trends, determine quality of research, prevent diseases, link legal citations, combat crime, and determine real-time roadway traffic conditions.

The processing, analysis, and modeling of financial transaction data by payment networks is one example of a large data set. Other examples include meteorology, genomics, complex physics simulations, and biological and environmental research. The limitations also affect Internet search, finance and business informatics. Data sets grow in size in part because they are increasingly being gathered by ubiquitous information-sensing mobile devices, aerial sensory technologies (remote sensing), software logs, cameras, microphones, radio-frequency identification readers, and wireless sensor networks.

Predictive modeling of large data sets is bounded by the memory size of a computer. Conventional algorithms (such as logical regression) in predictive modeling of large data sets involve inverting of a data matrix, which requires the whole data set to be loaded into computer memory. If the data set is larger than the memory working environment, it is not possible to build predictive models using traditional in-memory modeling environments such as the “R” programming language, Python or Matlab. As a result, big data is difficult to work with using most relational database management systems and desktop statistics and visualization packages, requiring instead massively parallel software running on tens, hundreds, or even thousands of servers. Such software and servers add extra cost to modeling large data sets.

### SUMMARY

Embodiments include a system, device, method and computer readable medium configured to model large amounts of data in an in-memory modeling environment.

An in-memory modeling embodiment stores a data set in a relational database stored in a non-transitory computer readable storage medium. The data set including observations and variables. A processor stratifies the data set into smaller samples within the relational database. For each of the smaller samples, the processor calculates a total variation distance between a selected independent variable using a dependent variable. The processor imports the screened smaller samples into a memory, and executes the virtual model using the screened smaller samples.

### BRIEF DESCRIPTION OF THE DRAWINGS

FIG. 1 depicts a block diagram of a modeling device configured to model large amounts of data in an in-memory modeling environment.

FIG. 2 flowcharts a method embodiment to model large amounts of data in an in-memory modeling environment.

### DETAILED DESCRIPTION

One aspect of the disclosure includes the realization that predictive modeling of large amounts of financial data in an in-memory modeling environment may be accomplished by loading the data set into a relational database, breaking the data set into manageable size, reducing the data set with a minimal loss of information, and outputting the data that could be fitted into memory in a predictive modeling environment.

Another aspect of the disclosure includes the realization that the embodiments described herein may be applied to any “big data” in-memory modeling problem—not just financial services.

Embodiments of the present disclosure include a system, method, and computer readable storage medium configured to model large amounts of data in an in-memory modeling environment. Embodiments are not limited by the size of the data and are flexible in terms of controlling the data to be fed into an in-memory modeling environment. Embodiments limit the loss of information from reducing the data set and therefore increase the prediction power of the resulting model.

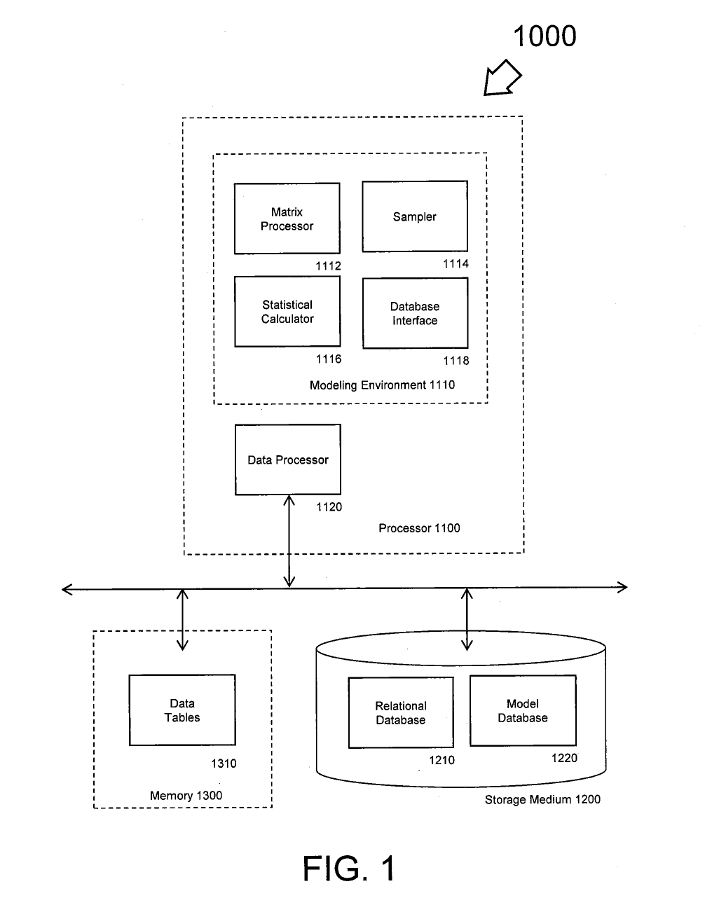

FIG. 1 illustrates an embodiment of a modeling device 1000 configured to model large amounts of data in an in-memory modeling environment, constructed and operative in accordance with an embodiment of the present disclosure.

Modeling device 1000 may run a multi-tasking operating system (OS) and include at least one processor or central processing unit (CPU) 1100, a non-transitory computer readable storage medium 1200, and computer memory 1300.

Processor 1100 may be any central processing unit, microprocessor, micro-controller, computational device or circuit known in the art.

As shown in FIG. 1, processor 1100 is functionally comprised of a modeling environment 1110 and a data processor 1120.

Modeling environment 1110 is configured to execute a virtual model. The virtual model may be a financial simulation, such as a payment-card fraud detection models, recommendation engines, and the like. Other virtual models include meteorology models, genomics models, complex physics simulations, and biological or environmental research models. It is understood by one of ordinary skill that any type of complex mathematical model that may use general linear regression, Lasso or ridge regression, or Gains charts may be modeled by a virtual model within modeling environment 1110. Furthermore, modeling environment 1110 may comprise: matrix processor 1112, sampler 1114, statistical calculator 1116, and database interface 1118.

Matrix processor 1112 is the element of processor 1100 that allows the performance of mathematical computations on matrices, such as matrix multiplication, linear transformations, matrix inversions and the like. In some embodiments, matrix processor 1112 may be a mathematics co-processor separate from processor 1100 itself, or part of a central processing unit integrated circuit.

Sampler 1114 enables processor 1100 to sample, slice, variable screen, and otherwise process a dataset into manageable small chunks.

Statistical calculator 1116 is the portion of the processor 1100 that performs statistical analysis. For example, statistical calculator 1116 may be able to determine the total variation distance between two probability measures. In some embodiments, statistical calculator is configured to perform a Kolmogorov-Smirnov test (K-S test), Shapiro-Wilk test, Anderson-Darling test, or the like.

Database interface 1118 is the application program interface (API) that allows modeling environment to communicate with databases.

Data processor 1120 enables processor 1100 to interface with memory 1300, storage medium 1200, or any other component not on the processor 1100. The data processor 1120 enables processor 1100 to locate data on, read data from, and write data to these components.

These structures may be implemented as hardware, firmware, or software encoded on a computer readable medium, such as storage medium 1200. Further details of these components are described with their relation to method embodiments below.

Memory 1300 may be any computer memory known in the art for volatile or non-volatile storage of data or program instructions. An example memory 1300 may be Random Access Memory (RAM). As shown, memory 1300 may store data tables 1310, for instance.

Computer readable storage medium 1200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer readable memory device as is known in the art for storing and retrieving data. Significantly, computer readable storage medium 1200 may be remotely located from processor 1100, and be connected to processor 1100 via a network such as a local area network (LAN), a wide area network (WAN), or the Internet.

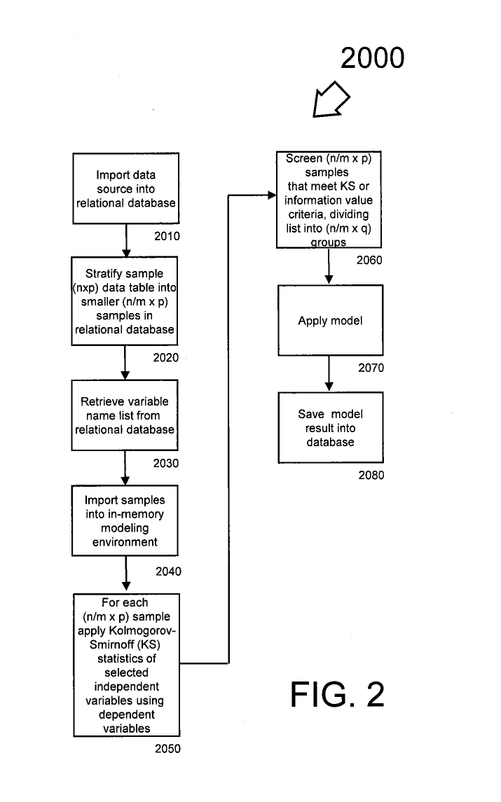

In addition, as shown in FIG. 2, storage medium 1200 may also contain a relational database 1210, and a model database 1220. Relational database 1210 may be any relational database known in the art, such as SQL, SQLite, MySQL, PosgreSQL, or the like. Model database 1220 is configured to store the model or result of the modeling environment 1110.

It is understood by those familiar with the art that one or more of these databases 1210-1220 may be combined in a myriad of combinations. The function of these structures may best be understood with respect to the flowcharts of FIG. 2, as described below.

We now turn our attention to method or process embodiments of the present disclosure, FIG. 2. It is understood by those known in the art that instructions for such method embodiments may be stored on their respective computer readable memory and executed by their respective processors. It is understood by those skilled in the art that other equivalent implementations can exist without departing from the spirit or claims of the disclosure.

FIG. 2 flowchart a modeling method 2000 embodiment to model large amounts of data in an in-memory modeling environment, constructed and operative in accordance with an embodiment of the present disclosure.

Typically, predictive modeling for large data sets is bounded by the memory size of the computing device. Method 2000 circumvents this limitation by storing the large data set on a non-transitory computer readable storage medium 1200, and intelligently sampling and slicing the dataset in the relational database 1210 into manageable chucks. The list of variables is screened with minimal loss of information, and the resulting output data is fitted into the memory 1300 for the modeling environment 1110. The resulting method 2000 is only minimally impacted by the size of the large data set, and flexible in terms of controlling the data to be fed into the in-memory modeling environment 1110 minimizes the loss of information.

Initially, the large data set of interest is imported into a relational database 1210 that is not limited by the size of the data, block 2010. The data set populates the relational database 1210 as a data table of n rows (observations) and p columns (variables), resulting in an n×p matrix.

At block 2020, sampler 1114 uses a stratified sampling method to sample the n×p matrix into m smaller samples in the relational database, (n/m×p, n/m×p, n/m×p . . . n/m×p), via the database interface 1118. Sampler 1114 chooses m based on the size of memory 1300, so that each n/m×p sized-data sample may fit within the modeling environment 1110. Because each n/m×p sized-data sample contains valuable information, sampler embodiments 1114 try to maximize the size of the sample, while allowing it to be encompassed within the memory 1300 allocated to the modeling environment 1110.

Through experimental analysis, lower and upper bounds for m have been determined.

2A/B<m<n/(50 q), where

A is the memory size of the n×p matrix,

B is the size of allotted available memory 1300,

n is the number of rows, and

q is a smaller sample size of the data table, as discussed below.

The variable name list is retrieved from the relational database 1210, block 2030.

For each n/m×p sized data sample, the sample is imported into the in-memory modeling environment 1110 at block 2040, and the total variation distance statistics is calculated between the selected independent variable using the dependent variable by the statistical calculator 1116, block 2050.

Note that in some statistical calculator 1116 embodiments, the total variation distance statistics is calculated using the Kolmogorov-Smirnov test. In such an embodiment, statistical calculator 1116 performs a nonparametric test for the equality of continuous, one-dimensional probability distributions that can be used to compare a sample with a reference probability distribution (one-sample K-S test), or to compare two samples (two-sample K-S test). The Kolmogorov-Smirnov statistic quantifies a distance between the empirical distribution function of the sample and the cumulative distribution function of the reference distribution, or between the empirical distribution functions of two samples. The null distribution of this statistic is calculated under the null hypothesis that the samples are drawn from the same distribution (in the two-sample case) or that the sample is drawn from the reference distribution (in the one-sample case). In each case, the distributions considered under the null hypothesis are continuous distributions but are otherwise unrestricted.

The two-sample KS test may be one of the nonparametric methods for comparing two samples, as it is sensitive to differences in both location and shape of the empirical cumulative distribution functions of the two samples.

In some embodiments, the Kolmogorov-Smirnov test may be modified to serve as a goodness of fit test. In the example case of testing for normality of the distribution, samples are standardized and compared with a standard normal distribution. This is equivalent to setting the mean and variance of the reference distribution equal to the sample estimates, and using these to define the specific reference distribution changes the null distribution of the test statistic.

It is understood by those familiar with the art that other total variation distance statistics tests, such as Shapiro-Wilk test, Anderson-Darling test, or the like may also be used.

Using the results of the total variation distance statistics, the data table is screened to an even smaller sample size of q smaller samples in the relational database, (n/m×q, n/m×q, n/m×q . . . n/m×q), block 2060. Using the results of the total variation distance statistics, selected variables (n/m×q₁, n/m×q₂, n/m×q₃ . . . n/m×qₗₐₛₜ) from each of the (n/m×p, n/m×p, n/m×p . . . n/m×p) samples, are bound to one data table (n/m×q), which is the resulting table. It is understood that method 2000 may flexibly control the size of the output data by appropriately choosing “m” and “q.” For example, if q˜200 in the final data, n/m˜10,000, which may be typical sizes for daily modeling. In other embodiments, n/m˜1000, which may resulting in q˜20. These choices for m and q allow systems to have flexibility, and fit the data within limited memory, and still allow adequate memory for computations to be carried out.

The resulting data may then be modeled within the memory 1300 of the modeling environment 1110, block 2070, and any results may be saved back into a model database 1220, block 2080.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. An in-memory modeling method comprising:
storing a data set in a relational database stored in a non-transitory computer readable storage medium, the data set including observations and variables;
stratifying the data set, with a processor, into smaller samples within the relational database;
for each of the smaller samples, calculating with the processor a total variation distance between a selected independent variable using a dependent variable;
screening, with the processor, the smaller samples based on the total variation distance;
importing the screened smaller samples into a memory; and,
executing a virtual model, with the processor, using the screened smaller samples.

2. The method of claim 1, further comprising:
storing a result of the virtual model in the non-transitory computer readable storage medium.

3. The method of claim 2, wherein the data set is stored as a data table.

4. The method of claim 3, wherein the calculating the total variation distance between the selected independent variable using the dependent variable uses a Kolmogorov-Smirnov test, Shapiro-Wilk test, or Anderson-Darling test.

5. The method of claim 4, wherein the virtual model is a financial services model.

6. The method of claim 5, wherein the financial services model is a recommendation engine, or payment transaction fraud detection model.

7. The method of claim 4, wherein the virtual model is a physics simulation.

8. A payment network apparatus comprising:
a non-transitory computer readable storage medium configured to store a data set in a relational database, the data set including observations and variables;
a processor configured to stratifying the data set, into smaller samples within the relational database; for each of the smaller samples, the processor is further configured to calculate a total variation distance between a selected independent variable using a dependent variable, to screen the smaller samples based on the total variation distance;
a memory configured to temporarily store the screened smaller samples,
wherein the processor is further configured to execute a virtual model, with the processor, using the screened smaller samples.

9. The apparatus of claim 8, wherein the non-transitory computer readable storage medium is further configured to store a result of the virtual model.

10. The apparatus of claim 9, wherein the data set is stored as a data table.

11. The apparatus of claim 10, wherein the calculating the total variation distance between the selected independent variable using the dependent variable uses a Kolmogorov-Smirnov test, Shapiro-Wilk test, or Anderson-Darling test.

12. The apparatus of claim 11, wherein the virtual model is a financial services model.

13. The apparatus of claim 12, wherein the financial services model is a recommendation engine, or payment transaction fraud detection model.

14. The apparatus of claim 11, wherein the virtual model is a physics simulation.

15. A non-transitory computer readable medium encoded with data and instructions, when executed by a computing device the instructions causing the computing device to:
store a data set in a relational database stored in the non-transitory computer readable storage medium, the data set including observations and variables;
stratify the data set, with a processor, into smaller samples within the relational database;
for each of the smaller samples, calculate with the processor a total variation distance between a selected independent variable using a dependent variable;
screen, with the processor, the smaller samples based on the total variation distance;
import the screened smaller samples into a memory; and,
execute a virtual model, with the processor, using the screened smaller samples.

16. The non-transitory computer readable medium of claim 15, wherein the non-transitory computer readable storage medium is further configured to:
store a result of the virtual model.

17. The non-transitory computer readable medium of claim 16, wherein the data set is stored as a data table.

18. The non-transitory computer readable medium of claim 17, wherein the calculating the total variation distance between the selected independent variable using the dependent variable uses a Kolmogorov-Smirnov test, Shapiro-Wilk test, or Anderson-Darling test.

19. The non-transitory computer readable medium of claim 18, wherein the virtual model is a financial services model.

20. The non-transitory computer readable medium of claim 19, wherein the financial services model is a recommendation engine, or payment transaction fraud detection model.
